(19) United States
(12) Patent Application Publication
(10) Pub. No.: US 2016/0358399 A1
(43) Pub. Date: Dec. 8, 2016

(54) METHOD AND SYSTEM FOR RECOGNIZING BILL WITH ABNORMAL THICKNESS

(71) Applicant: GRG Banking Equipment Co., Ltd., Guangzhou, Guangdong (CN)

(72) Inventors: Tiancai LIANG, Guangzhou, Guangdong (CN); Xiaoliang WANG, Guangzhou, Guangdong (CN); Guang CHEN, Guangzhou, Guangdong (CN); Siwei LIU, Guangzhou, Guangdong (CN)

(73) Assignee: GRG Banking Equipment Co., Ltd., Guangzhou, Guangdong (CN)

(21) Appl. No.: 15/102,443

(22) PCT Filed: Sep. 29, 2014
(86) PCT No.: PCT/CN2014/087746

§ 371 Date: Jun. 7, 2016

(30) Foreign Application Priority Data
Dec. 12, 2013 (CN) 201310684625.X

(51) Int. Cl. G07D 7/16; B65H 43/04

(52) U.S. Cl. CPC G07D 7/164; B65H 43/04; B65H 2701/1912

(57) ABSTRACT

A method and system for recognizing a bill with an abnormal thickness. The method comprises: collecting the thickness signals of the bills in multi-channel to obtain multi-channel thickness signals (501); preprocessing the multi-channel thickness signals (502); searching the mutation points inside the multi-channel thickness signals according to a predetermined rule to form a mutation point set (503); determining the abnormal thickness suspicious regions of the multi-channel thickness signals according to the mutation point set (504); determining the thickness signal abnormal regions of the multi-channel thickness signals according to the abnormal thickness suspicious regions, and marking the positions and the area of the thickness signal abnormal regions (505); fusing the positions and the area of the thickness signal abnormal regions of the multi-channel thickness signals to obtain a fused result (506); recognizing the fused result to obtain a recognizing result (507). The recognizing method can effectively solve a problem of misjudging a normal bill due to a larger amplitude value fluctuation of a harmonic signal and a problem of missing a damaged bill, a counterfeit bank note or the like caused by insufficient signal sampling through lower calculation complexity in manner of detecting the mutation point of the thickness signal.

### FIELD

The embodiments of the present disclosure relates to the technical field of paper currency processing, and particularly to a method and a system for recognizing a banknote with an abnormal thickness.

### BACKGROUND

Different from a circulation banknote, a banknote with an abnormal thickness described below includes a damaged banknote and a composite banknote. In a circulation process of the banknote, a banknote is normally dilapidated since the banknote is torn or a corner of the banknote is lost, the damaged banknote refers to a banknote formed by recovering the dilapidated banknote in a pasting way, the damaged banknote in circulation seriously affects the banknote image and the national image, and therefore, the damaged banknote should be recalled and destroyed in a concentrated way based on relevant regulations of the central bank; the composite banknote refers to a banknote formed by recombining incomplete parts from different banknotes by outlaws in a way of pasting, patching and so on, added value can be realized by the way of pasting, patching and so on. Since the damaged banknote and the composite banknote do harm to the benefits of the state, the collective and individual to some extent, a financial currency detection device should have an ability of distinguishing the banknote with an abnormal thickness.

A current financial currency detection device is provided with a thickness sensor, and is configured to recognize a collected thickness signal of the banknote by a sliding searching method, to recognize the banknote with an abnormal thickness.

Due to limitations by machine cost and a whole machine structure, with reference to FIG. 1 and FIG. 2, the number of thickness sensors in the current financial currency detection device is small, and a gap exists between the thickness sensors since a width of a banknote passing channel is made large to make sure that the banknote passes through smoothly. When a foreign body pasted on a surface of the banknote passes through the gap between two sensors in a banknote passing process, a value at which a thickness signal at a region of the foreign body on the banknote skips is a little bit less than a normal value, in this case, a region with an abnormal thickness may not be searched out by a sliding window, therefore, the banknote on which the foreign body is pasted is missed.

With reference to FIG. 3 and FIG. 4, there is a case that the banknote is not flat in a banknote passing process and electromagnet interference occurs in a process of collecting the thickness signal of the banknote, which results in that the thickness signal of the normal banknote includes a harmonic signal (that is, a signal in a wave-like shape). In a case that the thickness signal of the banknote is recognized by the sliding searching method and the sliding window is located at a position of a wave peak of the harmonic signal, since an amplitude value of the thickness signal in the region is relatively high, the region is taken as a region with an abnormal thickness by mistake, therefore, a normal banknote is determined as the banknote with an abnormal thickness.

### SUMMARY

A method and a system for recognizing a banknote with an abnormal thickness are provided by the embodiments of the present disclosure, which can effectively solve a problem of misjudging a normal banknote caused by a large amplitude value fluctuation of a harmonic signal and a problem of missing a damaged banknote, a composite banknote or the like caused by insufficient signal sampling by lower calculation amount in a manner of detecting a jump point of a thickness signal.

A method for recognizing a banknote with an abnormal thickness is provided according to an embodiment of the present disclosure, which includes:
collecting, through multiple channels, thickness signals of a banknote to obtain a plurality of thickness signals;
preprocessing the plurality of thickness signals;
searching for jump points in the plurality of thickness signals according to a predetermined rule, to form a jump point set;
determining abnormal thickness suspicious regions of the plurality of thickness signals based on the jump point set;
determining thickness signal abnormal regions of the plurality of thickness signals based on the abnormal thickness suspicious regions, and marking positions and areas of the thickness signal abnormal regions;
combining the positions and the areas of the thickness signal abnormal regions of the plurality of thickness signals, to obtain a combining result; and
recognizing the combining result to obtain a recognizing result.

Optionally, after the step of preprocessing the plurality of thickness signals and before the step of searching for the jump points in the plurality of thickness signals according to the predetermined rule, the method further includes:
storing the plurality of preprocessed thickness signals.

Optionally, after the step of recognizing the combining result to obtain the recognizing result, the method further includes:
categorizing the banknote based on the recognizing result, and delivering the banknote to a position corresponding to a category.

Optionally, the step of preprocessing the plurality of thickness signals includes:
sampling the plurality of thickness signals, to obtain sampled signals;
de-noising the sampled signals, to obtain de-noised signals; and
determining a valid signal region of the de-noised signals, to obtain the valid signal region.

Optionally, the step of searching for the jump points in the plurality of thickness signals according to the predetermined rule to form the jump point set includes:
reading a determination condition for an upper-deformation jump point and a lower-deformation jump point;
searching for jump points in the plurality of thickness signals according to the determination condition; and
storing the jump points into the jump point set.

A system for recognizing a banknote with an abnormal thickness is provided in the embodiments of the present disclosure, which includes a thickness sensor, a DSP chip, an embedded module and a mechanical motion module.

The thickness sensor is connected to the DSP chip and is configured to collect thickness signals of a banknote.

The DSP chip is connected to the embedded module and is configured to perform analyzing and recognizing to the banknote based on the thickness signals, to obtain a recognizing result.

The embedded module is connected to the mechanical motion module and is configured to control the mechanical motion module based on the recognizing result.

The mechanical motion module is configured to categorize the banknote based on a control instruction set of the embedded module and deliver the banknote to a position corresponding to a category.

Optionally, the system further includes a storage module, which is configured to store the recognizing result.

Optionally, the thickness sensor is a multi-channel thickness sensor.

In the method for recognizing the banknote with an abnormal thickness according to the embodiment of the present disclosure, the thickness signals of the banknote are collected by multiple channels to obtain a plurality of thickness signals; the plurality of thickness signals are preprocessed; the jump points in the plurality of thickness signals are searched for according to a predetermined rule, to form the jump point set; the abnormal thickness suspicious regions of the plurality of thickness signals are determined based on the jump point set; the thickness signal abnormal regions of the plurality of thickness signals are determined based on the abnormal thickness suspicious regions, and the positions and the areas of the thickness signal abnormal regions are marked; the positions and the areas of the thickness signal abnormal regions of the plurality of thickness signals are combined, to obtain the combining result; the combining result is recognized to obtain the recognizing result. The method and the system for recognizing the banknote with an abnormal thickness can effectively solve a problem of misjudging a normal banknote caused by a large amplitude value fluctuation of a harmonic signal and a problem of missing a damaged banknote, a composite banknote or the like caused by insufficient signal sampling by lower calculation amount in a manner of detecting the jump points of the thickness signals.

### BRIEF DESCRIPTION OF THE DRAWINGS

FIG. 1 is a schematic diagram of a banknote passing process of a damaged banknote;

FIG. 2 is a schematic diagram of thickness signals of a damaged banknote;

FIG. 3 is a schematic diagram of recognizing thickness signals of a banknote by a sliding searching method in the conventional technology;

FIG. 4 is a schematic diagram of a harmonic signal that occurs when the thickness signal of the banknote is recognized by a sliding searching method in the conventional technology;

FIG. 5 is a flow diagram of a method for recognizing a banknote with an abnormal thickness according to a first embodiment of the present disclosure;

FIG. 6 is a schematic diagram of a type of a jump point in the embodiment of the present disclosure;

FIG. 7 is a schematic diagram of abnormal thickness suspicious regions in the embodiment of the present disclosure;

FIG. 8 is a flow diagram of a method for recognizing a banknote with an abnormal thickness according to a second embodiment of the present disclosure;

FIG. 9 is a schematic diagram of a banknote passing process of a composite banknote in the second embodiment of the present disclosure;

FIG. 10 is a schematic diagram of thickness signals of a composite banknote in the second embodiment of the present disclosure;

FIG. 11 is a schematic diagram of a jump point set in the second embodiment of the present disclosure;

FIG. 12 is a schematic diagram of abnormal thickness suspicious regions in the second embodiment of the present disclosure; and

FIG. 13 is a schematic structural diagram of a system for recognizing a banknote with an abnormal thickness according to an embodiment of the present disclosure.

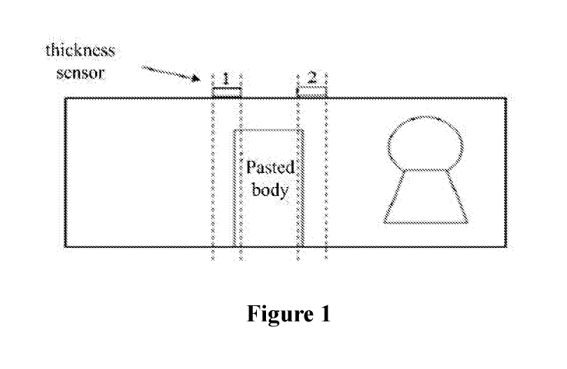

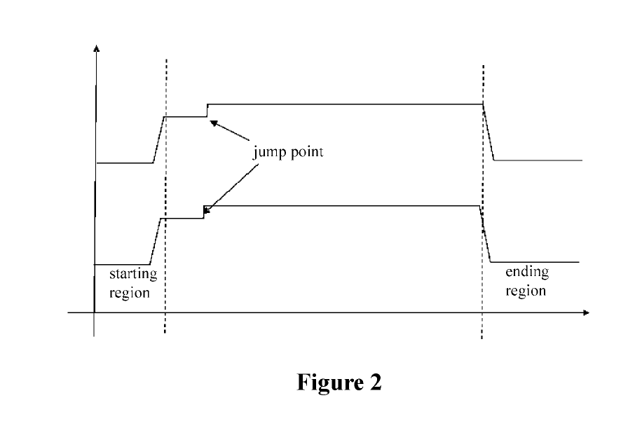

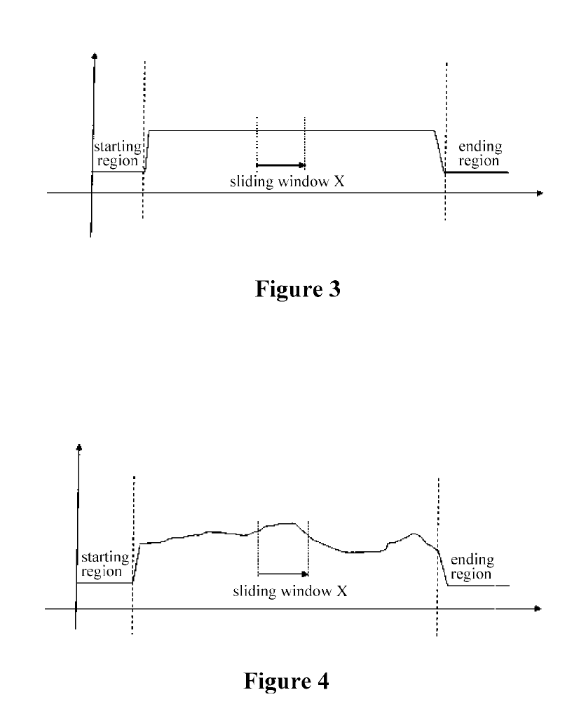

### DETAILED DESCRIPTION

A method and a system for recognizing the banknote with an abnormal thickness can effectively solve a problem of misjudging a normal banknote caused by a large amplitude value fluctuation of a harmonic signal and a problem of missing a damaged banknote, a composite banknote or the like caused by insufficient signal sampling by lower calculation amount in a manner of detecting jump points of thickness signals.

It should be illustrated that the method and the system for recognizing the banknote with an abnormal thickness according to the embodiments of the present disclosure can be applied to not only recognize the banknote, but also recognize a slice-type document such as check, which is not limited here. The method and the device according to the embodiments of the present disclosure are illustrated by taking banknote recognition as an example, although the banknote recognition is taken as an example, the method and the device according to the present disclosure are not limited thereto.

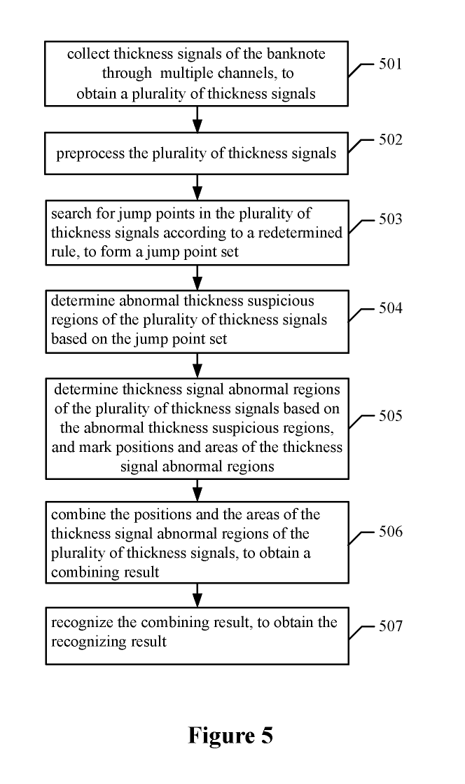

With reference to FIG. 5, a method for recognizing a banknote with an abnormal thickness according to a first embodiment of the present disclosure includes steps 501 to 507.

In 501, thickness signals of the banknote are collected through multiple channels, to obtain a plurality of thickness signals.

Before the banknote is recognized, the thickness signals of the banknote are collected by a multi-channel thickness sensor, to obtain the plurality of thickness signals.

In 502, the plurality of thickness signals is preprocessed.

After the plurality of thickness signals are obtained, the plurality of thickness signals are preprocessed, to recognize the plurality of thickness signals.

In 503, jump points in the plurality of thickness signals are searched for according to a predetermined rule, to form a jump point set.

After the plurality of thickness signals are preprocessed, the jump points in the plurality of thickness signals are searched for according to the predetermined rule, to form the jump point set.

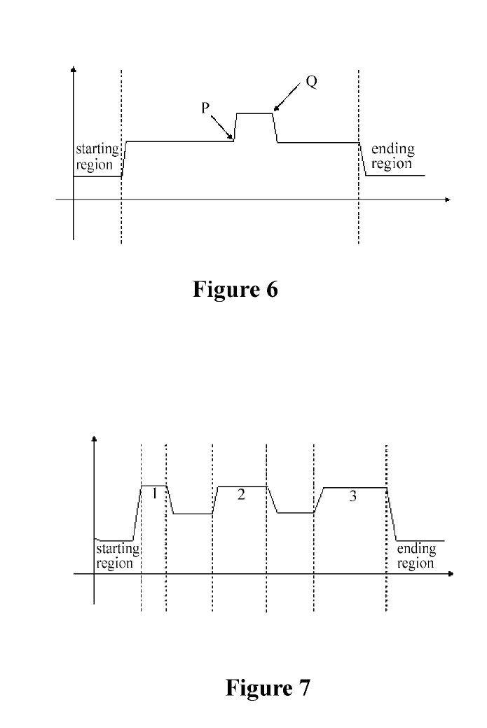

With reference to FIG. 6, the jump points described above may include an upper jump point and a lower jump point, a set compose of the jump points described above is referred to as the jump point set.

In 504, abnormal thickness suspicious regions of the plurality of thickness signals are determined based on the jump point set.

After the jump point set is obtained, the abnormal thickness suspicious regions of the plurality of thickness signals are determined based on the jump point set. With reference to FIG. 7, the abnormal thickness suspicious regions described above may include a starting-lower deformation suspicious region, an upper deformation-lower deformation suspicious region and an upper deformation-ending suspicious region. A starting point of a region 1 in FIG. 7 is a signal starting point, and an ending point of the region 1 in FIG. 7 is a lower-deformation jump point, thus the region 1 is referred to as the starting-lower deformation suspicious region, similarly, region 2 is referred to as the upper deformation-lower deformation suspicious region, and region 3 is the upper deformation-ending suspicious region.

In 505, thickness signal abnormal regions of the plurality of thickness signals are determined based on the abnormal thickness suspicious regions, and positions and areas of the thickness signal abnormal regions are marked.

After the abnormal thickness suspicious regions of the plurality of thickness signals are determined, the thickness signal abnormal regions of the plurality of thickness signals are determined based on the abnormal thickness suspicious regions, and the positions and the areas of the thickness signal abnormal regions are marked.

In 506, the positions and the areas of the thickness signal abnormal regions of the plurality of thickness signals are combined, to obtain a combining result.

After the positions and the areas of the thickness signal abnormal regions are marked, the positions and the areas of the thickness signal abnormal regions of the plurality of thickness signals are combined, to obtain the combining result.

In 507, the combining result is recognized to obtain a recognizing result.

After the combining result is obtained, the combining result is recognized to obtain the recognizing result.

In the method for recognizing the banknote with an abnormal thickness according to the embodiment of the present disclosure, the thickness signals of the banknote are collected through multiple channels to obtain a plurality of thickness signals. The plurality of thickness signals is preprocessed. The jump points in the plurality of thickness signals are searched for according to a predetermined rule, to form the jump point set. The abnormal thickness suspicious regions of the plurality of thickness signals are determined based on the jump point set. The thickness signal abnormal regions of the plurality of thickness signals are determined based on the abnormal thickness suspicious regions, and the positions and the areas of the thickness signal abnormal regions are marked. The positions and the areas of the thickness signal abnormal regions of the plurality of thickness signals are combined, to obtain the combining result. And finally the combining result is recognized to obtain the recognizing result. The method for recognizing the banknote with an abnormal thickness can effectively address an issue of misjudging a normal banknote caused by a large amplitude value fluctuation of a harmonic signal and a problem of missing a damaged banknote, a composite banknote or the like caused by insufficient signal sampling by lower calculation amount in a manner of detecting the jump points of the thickness signals.

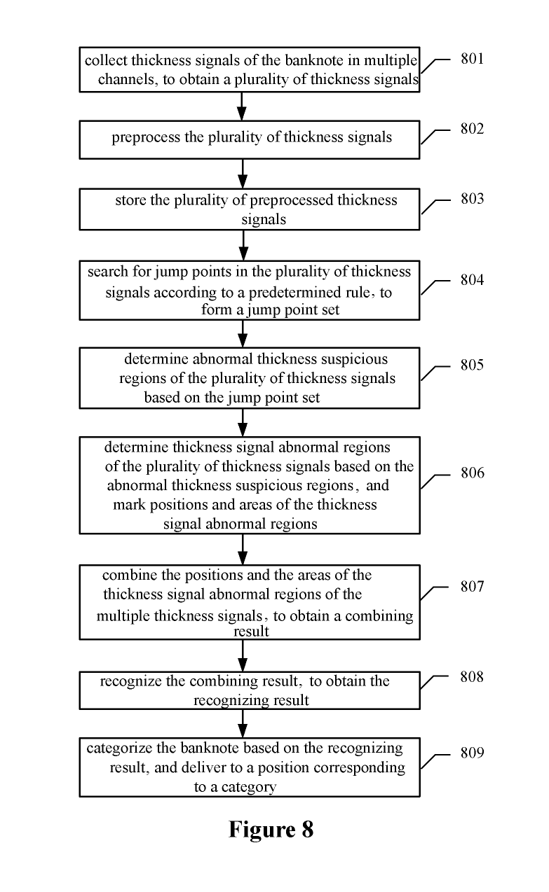

The method for recognizing the banknote with an abnormal thickness according to the first embodiment of the present disclosure is introduced simply as above, a method for recognizing the banknote with an abnormal thickness according to a second embodiment of the present disclosure is described in detail, with reference to FIG. 8, the method for recognizing the banknote with an abnormal thickness according to the second embodiment of the present disclosure includes steps 801 to 809.

In 801, thickness signals of the banknote are collected by multiple channels, to obtain a plurality of thickness signals.

Before the banknote is recognized, the thickness signals of the banknote are collected by a multi-channel thickness sensor, to obtain the plurality of thickness signals.

In 802, the plurality of thickness signals is preprocessed.

After the plurality of thickness signals are obtained, the plurality of thickness signals are preprocessed, to recognize the plurality of thickness signals. The preprocessing described above may include: sampling the plurality of thickness signals, to obtain sampled signals; de-noising the sampled signals, to obtain de-noised signals; and determining a valid signal region of the de-noised signals, to obtain the valid signal region. The preprocessing described above mainly aims to reduce an influence on the thickness signals from outside.

In 803, the plurality of preprocessed thickness signals is stored.

After the plurality of thickness signals is preprocessed, the plurality of thickness signals in the valid signal region may be stored. Specifically, the plurality of preprocessed thickness signals is stored in an internal storage in a processor.

In 804, jump points in the plurality of thickness signals are searched for according to a predetermined rule, to form a jump point set.

After the plurality of preprocessed thickness signals are stored, the jump points in the plurality of thickness signals are searched for according to the predetermined rule, to form the jump point set.

With reference to FIG. 6, the jump points described above may include an upper jump point and a lower jump point, a set compose of the jump points described above is referred to as the jump point set.

A process of the searching for jump points in the plurality of thickness signals according to the predetermined rule to form the jump point set may include: reading a determination condition for an upper-deformation jump point and a lower-deformation jump point; searching for jump points in the plurality of thickness signals according to the determination condition; and storing the jump points into the jump point set.

In 805, abnormal thickness suspicious regions of the plurality of thickness signals are determined based on the jump point set.

After the jump point set is obtained, the abnormal thickness suspicious regions of the plurality of thickness signals are determined based on the jump point set. With reference to FIG. 7, the abnormal thickness suspicious regions described above may include a starting-lower deformation suspicious region, an upper deformation-lower deformation suspicious region and an upper deformation-ending suspicious region. A starting point of a region 1 in FIG. 7 is a signal starting point, and an ending point of the region 1 in FIG. 7 is a lower-deformation jump point, and the region 1 is referred to as the starting-lower deformation suspicious region, similarly, region 2 is referred to as the upper deformation-lower deformation suspicious region, and region 3 is the upper deformation-ending suspicious region.

In 806, thickness signal abnormal regions of the plurality of thickness signals are determined based on the abnormal thickness suspicious regions, and positions and areas of the thickness signal abnormal regions are marked.

After the abnormal thickness suspicious regions of the plurality of thickness signals are determined, the thickness signal abnormal regions of the plurality of thickness signals are determined based on the abnormal thickness suspicious regions, and the positions and the areas of the thickness signal abnormal regions are marked.

In 807, the positions and the areas of the thickness signal abnormal regions of the plurality of thickness signals are combined, to obtain a combining result.

After the positions and the areas of the thickness signal abnormal regions are marked, the positions and the areas of the thickness signal abnormal regions of the plurality of thickness signals are combined, to obtain the combining result.

In 808, the combining result is recognized, to obtain a recognizing result.

After the combining result is obtained, the combining result is recognized to obtain the recognizing result. In a case that the combining result shows that a discrimination region is covered by the abnormal region, the banknote is recognized as a composite banknote, or in a case that the combining result shows that the area of the abnormal region is greater than a fixed threshold, the banknote is recognized as a damaged banknote; or else, the banknote is recognized as a circulation banknote.

It should be illustrated that, the fixed threshold described above is preset based on a banknote to be detected and a device structure, which is not limited here.

In 809, the banknote is categorized based on the recognizing result, and then is sent to a position corresponding to a category.

After the recognizing result is obtained, the banknote is categorized based on the recognizing result, and then is sent to the position corresponding to the category, for example, different types of banknotes may be transmitted to preset storage bins, to realize banknote recognition.

An operation process of the embodiment of the present disclosure is described in detail below by a specific example.

Inputs of the recognition system are different based on a currency type of a banknote, a type of a sensor and a motion speed of the banknote. Assuming that a thickness of a banknote to be detected is THK±0.15 THK, a minimal pasting thickness which can be detected by the sensor is thk.

In a first step, thickness signals of a banknote are collected by multiple channels.

The thickness signal of the banknote is collected by a Hall sensor, there are M-channel thickness signals in total, and the number of points collected for each channel of the M-channel thickness signals is N.

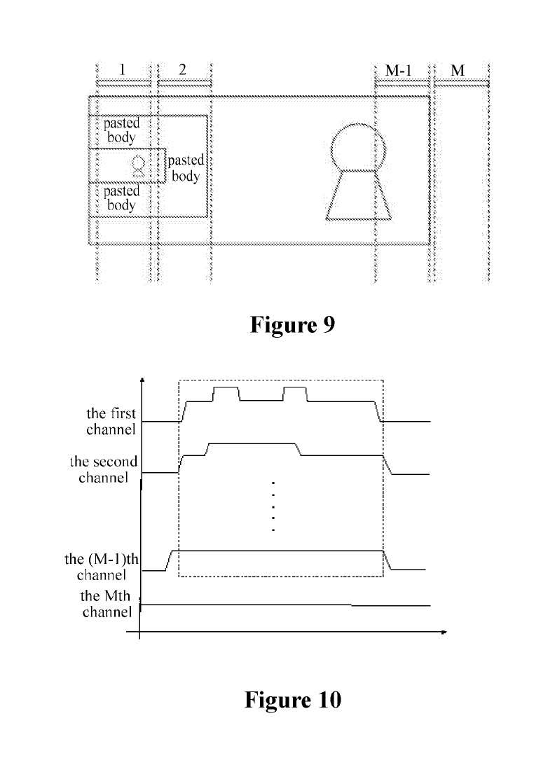

With reference to FIG. 9, which is a schematic diagram of a banknote passing process of a composite banknote, a sensor 1 and a sensor 2 cover a region in which a foreign body is pasted in the banknote passing process, and a sensor M does not cover a region of the banknote, collected patterns of the thickness signal collected by the sensors may refer to FIG. 10.

In a second step, the multiple-channel thickness signals are preprocessed.

In this process, the thickness signals are sampled, and de-noised, and then a valid signal region is extracted, a preprocessed signal is recorded as S(i, j), which may be stored in an interior storage unit of a signal processing chip for a subsequent step.

For the composite banknote in FIG. 9, with reference to FIG. 10, the valid signal region of the thickness signals extracted in the preprocessing process is a region selected by a black frame wire in FIG. 10.

In a third step, jump points in the plurality of thickness signals are searched for according to a predetermined rule, to form a jump point set.

A relevant constraint condition includes threshold values T₁=ηthk and T₂=−ηthk of a jump height for the jump points, where η∈[0, 7, 0, 9].

The thickness signal data S(i, j) is read, in a case that a signal sampling point S(i, j) meets a condition as follows,

$$\{ \begin{matrix}S ( i , j + Δ ) - S ( i , j ) > {T}_{1} \\ S ( i , j + Δ + 1 ) - S ( i , j + 1 ) > {T}_{1} \\ S ( i , j + Δ + 1 ) - S ( i , j + 1 ) > {T}_{1} , {T}_{1} > 0 ,\end{matrix}$$

the point S(i, j) is a upper-deformation jump point, and assuming Pᵢ(j)=j in this case, which represents that the jth sampling point in the ith channel signal is the upper-deformation jump point, or in a case that the signal sampling point S(i, j) does not meet the determination condition described above, assuming Pᵢ(j)=0 in this case, which represents that the jth sampling point in the ith channel signal is not the upper-deformation jump point.

In a case that the signal sampling point S(i, j) meets a condition as follows,

$$\{ \begin{matrix}S ( i , j + Δ ) - S ( i , j ) < {T}_{2} \\ S ( i , j + Δ + 1 ) - S ( i , j + 1 ) < {T}_{2} \\ S ( i , j + Δ + 1 ) - S ( i , j + 1 ) < {T}_{2} , {T}_{2} < 0 ,\end{matrix}$$

the point S(i, j) is a lower-deformation jump point, and assuming Qᵢ(j)=−1 in this case, which represents that the jth sampling point in the ith channel is the lower-deformation jump point, or in a case that the signal sampling point S(i, j) does not meet the determination condition described above, assuming Qᵢ(j)=0 in this case, which represents that the jth sampling point in the ith channel is not the lower-deformation jump point.

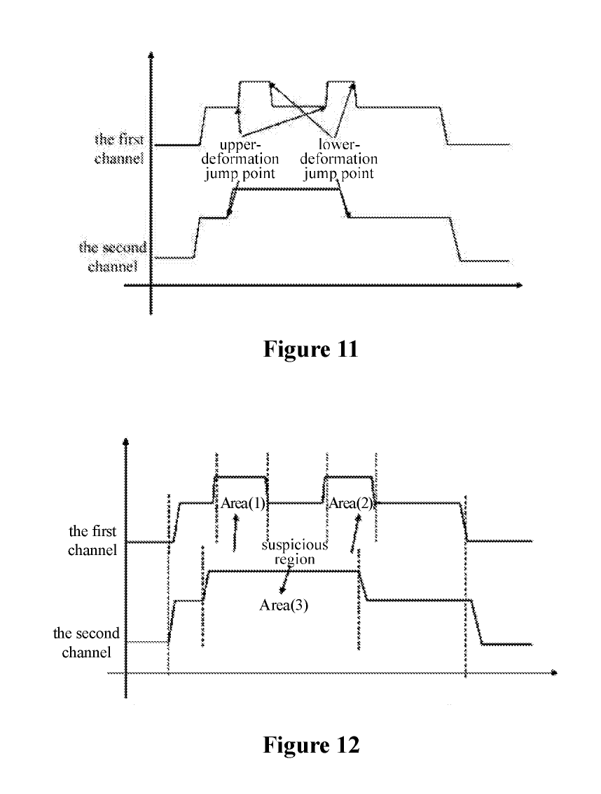

For the composite banknote in FIG. 9, two upper-deformation jump points and two lower-deformation jump points are detected in a first-channel thickness signal, and one upper-deformation jump point and one lower-deformation jump points are detected in a second-channel thickness signal by the method described above, which are shown in FIG. 11.

In the fourth step, abnormal thickness suspicious regions of the plurality of thickness signals are determined based on the jump point set.

PQᵢ represents a jump point set of the ith-channel signal, assuming that

$${PQ}_{i} ( j ) = \{ \begin{matrix}j & {P}_{i} ( j ) \neq 0 \\ - j & {Q}_{i} ( j ) \neq 0 \\ 0 & {P}_{i} ( j ) = 0 , {Q}_{i} ( j ) = 0\end{matrix} ,$$

non-zero elements in the jump point set PQᵢ above represent positions of jump points in the ith-channel thickness signal, PQᵢ(j)≧0 represents that the jth point is an upper-deformation jump point, and PQᵢ(j)>0 represents that the jth point is a lower-upper-deformation jump point, PQᵢ(j)=0 represents that the jth point is not the jump point, a type of the abnormal thickness suspicious region is determined below based on information on the positions of the jump points.

(1) a starting-lower-deformation suspicious region is determined, in a case that PQᵢ(j) meets a condition as follows,

for ∀k<j, PQᵢ(k)=0 and PQᵢ(j)=0,

then a starting lower-deformation suspicious region exists, and a starting point of the suspicious region is Pₛₜₐᵣₜ(i), and a length thereof is abs(PQᵢ(j))−Pₛₜₐᵣₜ(i).

(2) an upper-deformation-lower-deformation suspicious region is determined, in a case that PQᵢ(j) meets a condition as follows,

for: ∃m,j, let ∀k<j, k<j+m, then PQᵢ(k)=0, PQᵢ(j)>0 and PQᵢ(j+m)<0,

then an upper-deformation and lower-deformation suspicious region exists, and a starting point of the suspicious region is abs(PQᵢ(j)), and a length thereof is m.

(3) an upper-deformation-ending suspicious region is determined, in a case that PQᵢ(j) meets a condition as follows,

for ∀k>j, PQᵢ(k)=0 and PQᵢ(j)>0,

then an upper-deformation-ending suspicious region exists, a starting point of the suspicious region is: PQᵢ(j), and a length thereof is P_{end}(i)−PQᵢ(j).

For the composite banknote in FIG. 9, two upper-deformation and lower-deformation suspicious regions are detected in the first-channel thickness signal, and one upper-deformation and lower-deformation suspicious region is detected in a second-channel thickness signal by the method described above, which are shown in FIG. 12.

In a five step, thickness signal abnormal regions of the plurality of thickness signals are determined based on the abnormal thickness suspicious regions, and positions and areas of the thickness signal abnormal regions are marked.

A relevant constraint condition includes a threshold T_{Thk}=THK+η*thk for a mean value of the thickness of the abnormal regions, a threshold T_{std} for a standard deviation of the thickness of the abnormal regions, a threshold Tᵢ for a length of the abnormal regions, where the threshold Tᵢ is the number of sampling points of the signal in the width of lcm (the number of the sampling points of the signal can be calculated based on a sampling frequency for the signal and a banknote passing speed of the banknote).

A starting point of the ith abnormal thickness suspicious region is s, and a length thereof is 1, a mean value Thk and a standard deviation Std of the thickness of the suspicious region are calculated according to formulas below, respectively,

$${Thk}_{s} = \frac{{\sum }_{j = s}^{s + l} S ( i , j )}{l} , {Std}_{s} = \sqrt{\frac{{\sum }_{j = s}^{s + l} {( S ( i , j ) - {Thk}_{s} )}^{2}}{n}} .$$

In a case that the mean value and the standard deviation meet conditions as follows and the length of the suspicious region is long enough, it is determined that the region is the thickness signal abnormal region, that is, the region is determined as the thickness signal abnormal region in a case of meeting the conditions as follows.

$$\{ \begin{matrix}{Thk}_{s} > {T}_{Thk} \\ {Std}_{s} < {T}_{std} \\ l > {T}_{t}\end{matrix} ,$$

where δ, T_{std} and Tᵢ are empirical parameters.

A position and the area of the thickness signal abnormal region are marked as Area(k) and S_{Area(k)} (where k refers to the kth thickness signal abnormal region of the banknote, assuming that there are N thickness signal abnormal regions in total), in a case that the mean value and the standard deviation of the abnormal thickness suspicious region does not meet the determination condition described above, suspicion of the suspicious region is excluded.

For the composite banknote in FIG. 9, with reference to FIG. 12, two thickness signal abnormal regions Area(1) and Area(2) are detected in the first-channel thickness signal, and one thickness signal abnormal region Area(3) are detected in a second-channel thickness signal by the method described above, and the areas of the three thickness signal abnormal regions are S_{Area(1)}, S_{Area(2)} and S_{Area(3)} respectively.

In a sixth step, the positions and the areas of the thickness signal abnormal regions of the plurality of thickness signals are combined to obtain a combining result, and the combining result is recognized.

A relevant constraint condition includes: a position Area_{N} of a discrimination region (the position is set based on a currency type and a face value, for example, a discrimination region of 100 RMB is set as a watermarking region and a national-emblem region), a threshold T_{S} for the area of the thickness signal abnormal region (the threshold can be set based on different detection standards, for example, the threshold is 4 cm² in the ECB European Central Bank standard).

Based on the position Area (k) and the area S_{Area(k)} of the thickness signal abnormal region calculated above, a position Area and the total area S_{Area} of the thickness signal abnormal regions of the whole banknote are calculated as follows.

$$Area = {{⋃}^{N}}_{k = 1} Area ( k ) , {S}_{Area} = {\sum }_{k = 1}^{N} {S}_{Area ( k )} .$$

A recognition result is obtained according to the area and the position of the abnormal region, in a case that the discrimination region Area_{N} of the banknote is covered by the thickness signal abnormal region, the banknote is determined as a composite banknote, or in a case that the discrimination region Area_{N} of the banknote is not covered by the thickness signal abnormal region and the area of the thickness signal abnormal region is greater than the threshold T_{S} for the area of the thickness signal abnormal region, the banknote is determined as a damaged banknote, or else, the banknote is determined as a circulation banknote.

For the composite banknote in FIG. 7, the watermarking region is covered by the thickness signal abnormal region

$$Area = {{⋃}^{3}}_{k = 1} Area ( k ) ,$$

and the area

$${S}_{Area} = {\sum }_{k = 1}^{3} {S}_{Area ( k )}$$

of the thickness signal abnormal region is greater than the threshold T_{S} for the area of the thickness signal abnormal region, the banknote is determined as a composite banknote.

The method according to the embodiments of the present disclosure can effectively address an issue of misjudging a normal banknote caused by a large amplitude value fluctuation of a harmonic signal and a problem of missing a damaged banknote, a composite banknote or the like caused by insufficient signal sampling by lower calculation amount in a manner of detecting the jump points of the thickness signals.

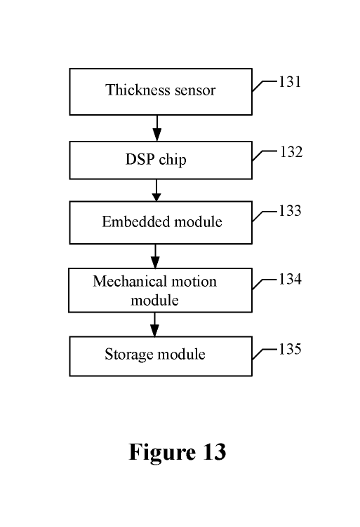

The method for recognizing the banknote with an abnormal thickness according to the second embodiment of the present disclosure is described in detail above, and a system for recognizing the banknote with an abnormal thickness according to an embodiment of the present disclosure is introduced below, with reference to FIG. 13, the system for recognizing the banknote with an abnormal thickness includes a thickness sensor 131, an DSP chip 132, an embedded module 133 and a mechanical motion module 134.

The thickness sensor 131 is connected to the DSP chip 132 and is configured to collect thickness signals of a banknote.

The DSP chip 132 is connected to the embedded module 133 and is configured to perform analyzing and recognizing on the banknote based on the thickness signals, to obtain a recognizing result.

The embedded module 133 is connected to the mechanical motion module 134 and is configured to control the mechanical motion module 134 based on the recognizing result.

The mechanical motion module 134 is configured to categorize the banknote based on a control instruction set of the embedded module 133 and deliver the banknote to a position corresponding to a category.

In the embodiment of the present disclosure, the thickness sensor 131 collects the thickness signals of the banknote first, and transmit the thickness signals described above to the

DSP chip 132 to perform analyzing and recognizing, the DSP chip 132 transmits the recognizing result to the embedded module 133 after obtaining the recognizing result, and the embedded module 133 controls the mechanical motion module 134 to transmit the circulation banknote, the damaged banknote and the composite banknote to different banknote outputting storage bins, to categorize different types of banknotes.

Optionally, the system further includes a storage module 135, which is configured to store the recognizing result.

Optionally, the thickness sensor 131 is a multi-channel thickness sensor.

The system according to the embodiment of the present disclosure can effectively address an issue of misjudging a normal banknote caused by a large amplitude value fluctuation of a harmonic signal and a problem of missing a damaged banknote, a composite banknote or the like caused by insufficient signal sampling by lower calculation amount in a manner of detecting the jump points of the thickness signals.

Those skilled in the art should understand that all of or a part of steps of the above method embodiments may be performed by instructing corresponding hardware through a program. The program may be stored in a computer readable storage medium. The storage medium may be a Read Only Memory, a magnetic disc or an optic disc.

The method and the system for recognizing the banknote with an abnormal thickness according to the present disclosure are introduced in detail above, for those skilled in the art, modification can be made to the specific embodiments and the application scopes based on the concept of the embodiments of the present disclosure, as above, the specification can not be understood to limit the present disclosure.

1. A method for recognizing a banknote with an abnormal thickness, comprising:
collecting thickness signals of a banknote through multiple channels to obtain a plurality of thickness signals;
preprocessing the plurality of thickness signals;
searching for jump points in the plurality of thickness signals according to a predetermined rule, to form a jump point set;
determining abnormal thickness suspicious regions of the plurality of thickness signals based on the jump point set;
determining thickness signal abnormal regions of the plurality of thickness signals based on the abnormal thickness suspicious regions, and marking positions and areas of the thickness signal abnormal regions;
combining the positions and the areas of the thickness signal abnormal regions of the plurality of thickness signals, to obtain a combining result; and
recognizing the combining result to obtain a recognizing result.

2. The method for recognizing the banknote with an abnormal thickness according to claim 1, wherein after the step of preprocessing the plurality of thickness signals and before the step of searching for the jump points in the plurality of thickness signals according to the predetermined rule, the method further comprises:
storing the plurality of preprocessed thickness signals.

3. The method for recognizing the banknote with an abnormal thickness according to claim 1, wherein after the step of recognizing the combining result to obtain the recognizing result, the method further comprises:
categorizing the banknote based on the recognizing result, and delivering the banknote to a position corresponding to a category.

4. The method for recognizing the banknote with an abnormal thickness according to claim 1, wherein the step of preprocessing the plurality of thickness signals comprises:
sampling the plurality of thickness signals, to obtain sampled signals;
de-noising the sampled signals, to obtain de-noised signals; and
determining a valid signal region of the de-noised signals, to obtain the valid signal region.

5. The method for recognizing the banknote with an abnormal thickness according to claim 1, the step of searching for the jump points in the plurality of thickness signals according to the predetermined rule to form the jump point set comprises:
reading a determination condition for an upper-deformation jump point and a lower-deformation jump point;
searching for jump points in the plurality of thickness signals according to the determination condition; and
storing the jump points into the jump point set.

6. A system for recognizing a banknote with an abnormal thickness, comprising: a thickness sensor, a DSP chip, an embedded module and a mechanical motion module, wherein
the thickness sensor is connected to the DSP chip and is configured to collect thickness signals of a banknote;
the DSP chip is connected to the embedded module, and is configured to perform analyzing and recognizing on the banknote based on the thickness signals, to obtain a recognizing result;
the embedded module is connected to the mechanical motion module and is configured to control the mechanical motion module based on the recognizing result; and
the mechanical motion module is configured to categorize the banknote based on a control instruction set of the embedded module and deliver the banknote to a position corresponding to a category.

7. The system for recognizing the banknote with an abnormal thickness according to claim 6, further comprising a storage module configured to store the recognizing result.

8. The system for recognizing the banknote with an abnormal thickness according to claim 7, wherein the thickness sensor is a multi-channel thickness sensor.

9. The method for recognizing the banknote with an abnormal thickness according to claim 2, wherein the step of preprocessing the plurality of thickness signals comprises:
sampling the plurality of thickness signals, to obtain sampled signals;
de-noising the sampled signals, to obtain de-noised signals; and
determining a valid signal region of the de-noised signals, to obtain the valid signal region.

10. The method for recognizing the banknote with an abnormal thickness according to claim 3, wherein the step of preprocessing the plurality of thickness signals comprises:
sampling the plurality of thickness signals, to obtain sampled signals;
de-noising the sampled signals, to obtain de-noised signals; and
determining a valid signal region of the de-noised signals, to obtain the valid signal region.

11. The method for recognizing the banknote with an abnormal thickness according to claim 2, the step of searching for the jump points in the plurality of thickness signals according to the predetermined rule to form the jump point set comprises:
reading a determination condition for an upper-deformation jump point and a lower-deformation jump point;
searching for jump points in the plurality of thickness signals according to the determination condition; and
storing the jump points into the jump point set.

12. The method for recognizing the banknote with an abnormal thickness according to claim 3, the step of searching for the jump points in the plurality of thickness signals according to the predetermined rule to form the jump point set comprises:
reading a determination condition for an upper-deformation jump point and a lower-deformation jump point;
searching for jump points in the plurality of thickness signals according to the determination condition; and
storing the jump points into the jump point set.
